(19) United States
(12) Patent Application Publication
(10) Pub. No.: US 2016/0032209 A1
(43) Pub. Date: Feb. 4, 2016

(54) LUBRICANT DEFOAMING ADDITIVES AND COMPOSITIONS

(71) Applicant: TRANE INTERNATIONAL INC., Piscataway, NJ (US)

(72) Inventors: Stephen Anthony KUJAK, Onalaska, WI (US); Julie Ann MAJURIN, La Crosse, WI (US); Daryl Dean STEINKE, Stoddard, WI (US)

(21) Appl. No.: 14/777,339

(22) PCT Filed: Mar. 14, 2014
(86) PCT No.: PCT/US2014/029022

§ 371 Date: Sep. 15, 2015

Related U.S. Application Data
(60) Provisional application No. 61/794,912, filed on Mar. 15, 2013.

(51) Int. Cl. C10M 107/28; C09K 5/04; C10M 105/76

(52) U.S. Cl. CPC C10M 107/28; C10M 105/76; C09K 5/044

(57) ABSTRACT

Defoaming compounds that can be included in a HVAC system are provided. In some embodiments, the refrigerant compositions and/or additives may include one or more defoaming compounds that have one or more of the following properties: helping reduce a surface tension of the lubricant and/or refrigerant; having a different surface tension than the lubricant and/or refrigerant; being substantially non-dissolvable with the refrigerant and/or lubricant; and/or having less dense than the refrigerant and/or lubricant so that the compounds may stay on the surface of the refrigerant and/or lubricant. In some embodiments, the defoaming compounds may be selected from mineral oil, silicone based oil, fatty alcohols, fatty acids, alky amines, treated silica, aluminum oxide, polyacrylates, acrylate esters polypropylene, alkyl sulfates, alkyl ethoxylate sulfates, alkyl aryl sulfonates, phosphate esters, quaternary ammonium compounds, fatty amine salts, fatty acid amides, alkyl phenol ethoxylates, ethoxylate-propoxylate polymers and fatty alcohol ethoxylates.

### FIELD

The disclosure herein relates to heating, ventilation, and air-conditioning (“HVAC”) systems, and more particularly to a defoaming compound that may help reduce foaming of lubricants, such as mineral oil, polyolester (POE), alkyl benzene (AB), polyalkylene glycol (PAG), polyalphaolefin (PAO), polyvinyl ether (PVE), or the combination thereof, used in the HVAC system during operation. The defoaming compound may be added to refrigerant and/or a lubricant of the HVAC system to form a refrigerant/lubricant composition, or may be included in another refrigerant/lubricant additive that can be added to the refrigerant and/or lubricant of the HVAC system to form a refrigerant/lubricant composition.

### BACKGROUND

A HVAC system, such as a chiller, generally includes a compressor, a condenser, an evaporator and an expansion device forming a refrigeration circuit that may be used for cooling/heating applications. In a cooling cycle of the HVAC system, the compressor can compress refrigerant vapor, and the compressed refrigerant vapor may be directed into the condenser to condense into liquid refrigerant. The liquid refrigerant can then be expanded by the expansion device and directed into the evaporator.

Components of the HVAC system, such as the compressor, may include moving parts, and may require lubrication during operation. Lubricants, such as oil, are commonly used in the HVAC system to lubricate the moving parts. The lubricant can be added to the refrigerant and circulated along with the refrigerant in the refrigeration circuit.

### SUMMARY

Embodiments are described to provide defoaming compounds that can be included in refrigerant/lubricant compositions and/or additives to help prevent/reduce lubricant foaming. In some embodiments, the refrigerant compositions and/or additives may include one or more defoaming compounds that may have one or more of the following properties: helping reduce a surface tension of the lubricant and/or refrigerant; having a different surface tension than the lubricant and/or refrigerant; being substantially non-dissolvable with the refrigerant and/or lubricant; and/or having less density than the refrigerant and/or lubricant so that the defoaming compound(s) may stay on the surface of the refrigerant and/or lubricant.

In some embodiments, the defoaming compound(s) may be selected from nonpolar oils, such as mineral oil, silicone based oil, polar oils such as fatty alcohols, fatty acids, alky amines, hydrophobic solids such as treated silica, aluminum oxide, polypropylene, surfactants such as alkyl sulfates, alkyl ethoxylate sulfates, alkyl aryl sulfonates, phosphate esters, quaternary ammonium compounds, fatty amine salts, fatty acid amides, alkyl phenol ethoxylates, ethoxylate-propoxylate polymers, acrylate esters, fatty alcohol ethoxylates and combinations thereof.

In some embodiments, a refrigerant/lubricant composition may include the defoaming compound from 0.0001% or about 0.0001% to 1% or about 1% by weight of the refrigerant/lubricant composition.

In some embodiments, the refrigerant composition may generally include hydrochlorofluorocarbon (HCFC), hydrofluorocarbon (HFC), unsaturated HFC's such as hydrochlorofluoroolefin (HCFO), hydrofluoroolefin (HFO) and/or other suitable refrigerants. In some embodiments, the refrigerant composition may include a refrigerant selected from a group including: 1-chloro-3,3,3 trifluoropropene (E), 1-chloro-3,3,3 trifluoropropene (Z), 2-chloro-3,3,3 trifluoropropene, 1,1,dichloro-3,3,3 trifluoropropene, 1,2 dichloro-3,3,3 trifluoropropene (E), 1,2 dichloro-3,3,3 trifluoropropene (Z), 1,3,3,3 tetrafluoropropene (E), 1,3,3,3 tetrafluoropropene (Z), 2,3,3,3 tetrafluoropropene, 1,1,2 trichloro-3,3,3 trifluoropropene, 1,2 dichloroethylene (E), 1,2 dichloroethylene (Z), 1,1 dichloroethylene, 1,1,1,4,4,4 hexafluorobutene (Z), 1,1,1,4,4,4 hexafluorobutene (E), 1,1,3,3 tetrafluoropropane, 1,1,1,2,3 pentafluoropropane, 1,1,2,3,3 pentafluoropropane, 1,1,1,3,3 pentafluoropropane, 1,1,1,2,2 pentafluoropropane, 1,1,1,2,2,3 hexafluoropropane, 1,1,1,2,3,3 hexafluoropropane, 1,1,1,3,3,3 hexafluoropropane, isopentane, pentane, cyclopentane, 1,1 difluoroethene, 1,2-difluoroethane, difluoromethane, 1,1,1,2 tetrafluoroethane, R1234ze (E), 1, 1 difluoroethane, 1,2 difluoroethene (E), 1,2 difluorethene (Z) or combinations thereof.

In some embodiments, the lubricant composition for a HVAC system may include 0.00025% or about 0.00025% to 0.0075% or about 0.0075% of silicone oil. In some embodiments, the lubricant composition may include 0.00025% or about 0.00025% to 0.1% or about 0.1% of polyacrylates or acrylate esters.

In some embodiments, the refrigerant/lubricant composition as disclosed herein can be used in production of a HVAC system to reduce foaming of a lubricant or when the HVAC system is in operation. In some embodiments, the refrigerant/lubricant additive as disclosed herein can be added to a HVAC system already in service to reduce foaming of the lubricant when the HVAC system is in operation.

Other features and aspects of the fluid management approaches will become apparent by consideration of the following detailed description.

### DETAILED DESCRIPTION

A HVAC system, such as a chiller system, may commonly include components with moving parts, such as rollers and balls of bearings of a compressor (such as a centrifugal compressor, a screw compressor and/or a scroll compressor). The moving parts generally require proper lubrication. The lubrication is commonly provided by a lubricant(s), such as a mineral oil, POE, AB, PAG, PAO and/or PVE based lubricant(s). The lubricant(s) can be added to the refrigerant and circulated along with the refrigerant in the HVAC system.

Using a lubricant(s) with the refrigerant can present some challenges. Refrigerant, such as hydrochlorofluorocarbons (HCFC), hydrofluorocarbons (HFC), unsaturated HFC's such as hydrochlorofluoroolefin (HCFO) and/or hydrofluoroolefin (HFO), can dissolve in the lubricant. In certain operation conditions, such as when the condenser temperature is relatively high (e.g. about 120° F.), or when the HVAC system starts when the components of the HVAC system is still at a relatively high temperature, the refrigerant dissolved in the lubricant can be suddenly released from the lubricant, causing lubricant foaming. The foaming of the lubricant can cause some operational or reliability issues. For example, foaming of the lubricant can cause the bearing lubricant delivery pump to malfunction and stop or slow the lubricant flow, which may cause component wear.

In another example, the lubricant foaming can lead to loss of lubricant from the lubricant sump to the other chiller system components and result in loss of lubricant flow as well to the bearing system. In addition, loss of lubricant to the other chiller components may require a significant amount of down time to recover the lost lubricant back to the lubricant delivery system. Refrigerant/lubricant compositions and/or additives are disclosed herein that can help prevent/reduce the foaming of the lubricant.

Embodiments are described herein to provide defoaming compounds that can be included in a refrigerant/lubricant composition and/or in an additive for a refrigerant/lubricant mixture to help prevent/reduce lubricant foaming. It is noted that the term “refrigerant composition” and the term “refrigerant/lubricant composition” are used interchangeably, and are generally referred to as a working fluid circulating in the HVAC system. The refrigerant composition may generally include refrigerant, a lubricant and/or other additive(s). The term “lubricant composition” generally means a composition that includes a lubricant and/or an additive(s), but does not include refrigerant.

In some embodiments, the refrigerant compositions and/or the additive may include one or more defoaming compounds that have one or more of the following properties: helping reduce a surface tension of the lubricant and/or refrigerant mixtures by, for example, 10% or about 10% to 80% or about 80%, more preferably 30% or about 30% to 60% or about 60% when the HVAC system is in operation; having a different surface tension than the lubricant and/or refrigerant mixtures in a range of, for example, 1 or about 1 to 60 or about 60 millinewtons per meter, more preferably 5 or about 5 to 40 or about 40 millinewton difference; being substantially non-dissolvable with the refrigerant and/or lubricant; and/or having less density than the refrigerant and/or lubricant so that the compounds may stay on the surface of the refrigerant and/or lubricant, for example, in an oil sump.

In some embodiments, the defoaming compounds may include non-polar oil, such as mineral oil and/or silicone based oil. In some embodiments, the defoaming compounds may include a polar oil, such as fatty alcohols, fatty acids and/or alky amines. In some embodiments, defoaming compounds may include hydrophobic solids, such as treated silica, aluminum oxide, and/or polypropylene. In some embodiments, the defoaming compounds may include surfactants, such as polyacrylates or acrylate esters, alkyl sulfates, alkyl ethoxylate sulfates, alkyl aryl sulfonates, phosphate esters, quaternary ammonium compounds, fatty amine salts, fatty acid amides, alkyl phenol ethoxylates, ethoxylate-propoxylate polymers, and/or fatty alcohol ethoxylates.

In some embodiments, the lubricant composition may include 0.00025% or about 0.00025% to 0.1% or about 0.1% of polyacrylates or acrylate esters.

In some embodiments, the refrigerant compositions may be made by adding one or more of the defoaming compounds to the refrigerant or the refrigerant/lubricant mixture. In some embodiments, the refrigerant composition may be made by adding the defoaming compound(s) into the lubricant to form a lubricant composition, and then mixing the lubricant composition with the refrigerant. In some embodiments, the additive may be premade by putting one or more of the defoaming compounds together. The premade additive can be added to the refrigerant and/or lubricant to form the refrigerant/lubricant composition(s) or lubricant composition(s). In some embodiments, the premade additive may be added to the HVAC system directly, for example, when retrofitting a HVAC system.

In some embodiments, the defoaming compounds may be added to the refrigerant in amounts of from 0.0001% or about 0.0001% to 1% or about 1% by weight of the final refrigerant composition with a preferred range of 0.0001% or about 0.0001% to 0.1% or about 0.1%. In some embodiments, the defoaming compounds may be added to the lubricant in amounts of from 0.0001% or about 0.0001% to 1% or about 1% by weight of the final lubricant composition with a preferred range of 0.0001% or about 0.0001% to 0.1% or about 0.1%.

In some embodiments, the defoaming compounds may be added to the refrigerant/lubricant mixture from 0.0001% or about 0.0001% to 1% or about 1% by weight of the final refrigerant/lubricant composition with a preferred range of 0.0001% or about 0.0001% to 0.1% or about 0.1% . In some embodiments, the additive may include one or more of defoaming compounds and may be added to the lubricant, the refrigerant or the refrigerant/lubricant mixture so that the final concentration of the defoaming compounds collectively may be from 0.0001% or about 0.0001% to 1% about 1% by weight of the final compositions with a preferred range of 0.0001% or about 0.0001% to 0.1% or about 0.1%.

In some embodiments, preferred refrigerant(s) that may be used with the defoaming compounds may be relatively environmental-friendly. In some embodiments, the preferred refrigerant to be used with the defoaming compounds may include one or blends of: 1-chloro-3,3,3 trifluoropropene (E), 1-chloro-3,3,3 trifluoropropene (Z), 2-chloro-3,3,3 trifluoropropene, 1,1,dichloro-3,3,3 trifluoropropene, 1,2 dichloro-3,3,3 trifluoropropene (E), 1,2 dichloro-3,3,3 trifluoropropene (Z), 1,3,3,3 tetrafluoropropene (E), 1,3,3,3 tetrafluoropropene (Z), 2,3,3,3, tetrafluoropropene, 1,1,2 trichloro-3,3,3 trifluoropropene, 1,2 dichloroethylene (E), 1,2 dichloroethylene (Z), 1,1 dichloroethylene, 1,1,1,4,4,4 hexafluorobutene (Z), 1,1,1,4,4,4 hexafluorobutene (E), 1,1,3,3 tetrafluoropropane, 1,1,1,2,3 pentafluoropropane, 1,1,2,3,3 pentafluoropropane, 1,1,1,3,3 pentafluoropropane, 1,1,1,2,2 pentafluoropropane, 1,1,1,2,2,3 hexafluoropropane, 1,1,1,2,3,3 hexafluoropropane, 1,1,1,3,3,3 hexafluoropropane, isopentane, pentane, cyclopentane, 1,1 difluoroethene, 1,2-difluoroethane, difluoromethane, 1,1,1,2 tetrafluoroethane, R1234ze (E), 1, 1 difluoroethane, 1,2 difluoroethene (E), 1,2 difluorethene (Z), or combinations thereof.

In one preferred embodiment, silicone oil may be added to a lubricant to 0.00025% or about 0.00025% to 0.005% or about 0.005% of the weight of the final lubricant composition. In one embodiment, may be added to a lubricant to 0.00025% or about 0.00025% to 0.0075% or about 0.0075% by the weight of the final lubricant composition. The final lubricant composition may be mixed with a refrigerant in a HVAC system. In some embodiments, the final lubricant composition may be mixed with the refrigerant at or about 1:2 ratio to at or about 1:100 ratio by weight.

The refrigerant/lubricant additive mixture (or composition) as disclosed herein can be added directly to the lubricant during a manufacturing process of the HVAC system, or during startup and/or service of the HVAC system. In some embodiments, the refrigerant/lubricant additive mixture (or composition) as disclosed herein can be added to a HVAC system already in service to reduce foaming. In some embodiments, the refrigerant/lubricant additive mixture (or composition) can be added to the refrigerant of the HVAC system. In some embodiments, the refrigerant/lubricant additive mixture (or composition) can be applied to the parts, such as the bearing, directly by, for example, spraying or dipping type application during the manufacturing process or during servicing of the HVAC system.

In some embodiments, the refrigerant/lubricant composition and/or the refrigerant/lubricant additive can be used with a chiller system with different types of compressors, such as a centrifugal compressor, a screw compressor, reciprocating compressor, rotary vane compressor or a scroll compressor.

It is to be appreciated that the defoaming compounds as disclosed herein may be used with lubricants to reduce lubricant foaming in other applications, such as, air compressors, and vacuum pumps.

### Experimental Results #1

About 0.005% of silicone oil was added to a lubricant for a HVAC system. Foaming of the lubricant was conducted by bubbling the lubricant with nitrogen gas through a fine glass frit. The foaming of the lubricant with the silicone oil resulted in only about 10% of the foaming of the lubricant without the silicone oil.

### Experimental Results #2

About 0.05% of polyacrylate or acrylate ester oil was added to a lubricant for a HVAC system. Foaming of the lubricant was conducted by bubbling the lubricant with nitrogen gas through a fine glass frit. The foaming of the lubricant with the polyacrylate or acrylate ester oil resulted in about 10% of the foaming of the lubricant without the additive.

### Aspects

Any of aspects 1-8 can be combined with any of aspects 9-19. Any of aspects 9 can be combined with any of aspects 10-19. Aspect 10 can be combined with any of aspects 11-19. Aspect 11 can be combined with any of aspects 12-19. Aspect 12 can be combined with any of aspects 13-19. Any of aspects 13-14 can be combined with any of aspects 15-19. Any of aspects 15-17 can be combined with any of aspects 18-19.
Aspect 1. A defoaming compound for a refrigerant/lubricant mixture in a HVAC system, comprising at least one compound that includes one or more properties of:
   reducing a surface tension of the refrigerant/lubricant mixture by 10% to 80%;
   having a different surface tension than the refrigerant/lubricant mixture in a range of 1 to 60 millinewtons per meter;
   being substantially non-dissolvable with the refrigerant/lubricant mixture; and
   having less density than the refrigerant/lubricant mixture.
Aspect 2. The defoaming compound of aspect 1, wherein the property of reducing the surface tension of the refrigerant/lubricant mixture is in a range of 30% to 60%.
Aspect 3. The defoaming compound of aspects 1-2, wherein the property of having the different surface tension than the refrigerant/mixture is in a range of 5 to 40 millinewtons per meter.
Aspect 4. The defoaming compound of aspects 1-3, comprising a compound selected from a group comprising: a non-polar oil, a polar oil, hydrophobic solids, surfactants, or a combination thereof.
Aspect 5. The defoaming compound of aspect 4, wherein the non-polar oil is selected from a group comprising:
   mineral oil, silicone based oil, or a combination thereof.
Aspect 6. The defoaming compound of aspects 4-5, wherein the polar oil is selected from a group comprising: fatty alcohols, fatty acids, alky amines, or a combination thereof.
Aspect 7. The defoaming compound of aspects 4-6, wherein the hydrophobic solids are selected from a group comprising: treated silica, aluminum oxide, polyacrylates, acrylate esters polypropylene, or a combination thereof.
Aspect 8. The defoaming compound of aspects 4-7, wherein the surfactants is selected from a group comprising: alkyl sulfates, alkyl ethoxylate sulfates, alkyl aryl sulfonates, phosphate esters, quaternary ammonium compounds, fatty amine salts, fatty acid amides, alkyl phenol ethoxylates, ethoxylate-propoxylate polymers, fatty alcohol ethoxylates or a combination thereof.
Aspect 9. A refrigerant composition comprising the defoaming compound of aspects 1-8, wherein the defoaming compound is from about 0.0001% to about 1% by weight of the refrigerant composition.
Aspect 10. The refrigerant composition of aspect 9, wherein the defoaming compound is from about 0.0001% to 0.1%
Aspect 11. The defoaming compound of aspects 1-8, wherein a refrigerant for the refrigerant/lubricant mixture is selected from a group comprising: 1-chloro-3,3,3 trifluoropropene (E), 1-chloro-3,3,3 trifluoropropene (Z), 2-chloro-3,3,3 trifluoropropene, 1,1,dichloro-3,3,3 trifluoropropene, 1,2 dichloro-3,3,3 trifluoropropene (E), 1,2 dichloro-3,3,3 trifluoropropene (Z), 1,3,3,3 tetrafluoropropene (E), 1,3,3,3 tetrafluoropropene (Z), 2,3,3,3, tetrafluoropropene, 1,1,2 trichloro-3,3,3 trifluoropropene, 1,2 dichloroethylene (E), 1,2 dichloroethylene (Z), 1,1 dichloroethylene, 1,1,1,4,4,4 hexafluorobutene (Z), 1,1,1,4,4,4 hexafluorobutene (E), 1,1,3,3 tetrafluoropropane, 1,1,1,2,3 pentafluoropropane, 1,1,2,3,3 pentafluoropropane, 1,1,1,3,3 pentafluoropropane, 1,1,1,2,2 pentafluoropropane, 1,1,1,2,2,3 hexafluoropropane, 1,1,1,2,3,3 hexafluoropropane, 1,1,1,3,3,3 hexafluoropropane, isopentane, pentane, cyclopentane, 1,1 difluoroethene, 1,2-difluoroethane, difluoromethane, 1,1,1,2 tetrafluoroethane, R1234ze (E), 1, 1 difluoroethane, 1,2 difluoroethene (E), 1,2 difluorethene (Z).
Aspect 12. An additive for a HVAC system comprising the defoaming compound of aspect 1.
Aspect 13. A refrigerant composition comprising the additive of aspect 12, wherein the additive is from about 0.0001% to about 1% by weight of the refrigerant composition.
Aspect 14. The refrigerant composition of aspect 13, wherein the additive is from about 0.0001% to 0.1%.
Aspect 15. A lubricant composition for a HVAC system, comprising about 0.00025% to 0.0075% of silicone oil.
Aspect 16. The lubricant composition of aspect 15, wherein the silicon oil is about 0.00025% to 0.005%.
Aspect 17. The lubricant composition of aspects 15-16, wherein the silicon oil is 0.005%.
Aspect 18. A lubricant composition for a HVAC system, comprising 0.00025% to 0.1% of polyacrylates, acrylate esters or a combination thereof.
Aspect 19. The lubricant composition of aspect 18, wherein the polyacrylates, acrylate esters or a combination thereof is about 0.05%.

With regard to the foregoing description, it is to be understood that changes may be made in detail, without departing from the scope of the present invention. It is intended that the specification and depicted embodiments are to be considered exemplary only, with a true scope and spirit of the invention being indicated by the broad meaning of the claims.

What claimed is:

1. A defoaming compound for a refrigerant/lubricant mixture in a HVAC system, comprising at least one compound that includes one or more properties of:
reducing a surface tension of the refrigerant/lubricant mixture by 10% to 80%;
having a different surface tension than the refrigerant/lubricant mixture in a range of 1 to 60 millinewtons per meter;
being substantially non-dissolvable with the refrigerant/lubricant mixture; and
having less density than the refrigerant/lubricant mixture.

2. The defoaming compound of claim 1, wherein the property of reducing the surface tension of the refrigerant/lubricant mixture is in a range of 30% to 60%.

3. The defoaming compound of claim 1, wherein the property of having the different surface tension than the refrigerant/mixture is in a range of 5 to 40 millinewtons per meter.

4. The defoaming compound of claim 1, comprising a compound selected from a group comprising: a non-polar oil, a polar oil, hydrophobic solids, surfactants, or a combination thereof.

5. The defoaming compound of claim 4, wherein the non-polar oil is selected from a group comprising:
mineral oil, silicone based oil, or a combination thereof.

6. The defoaming compound of claim 4, wherein the polar oil is selected from a group comprising: fatty alcohols, fatty acids, alky amines, or a combination thereof.

7. The defoaming compound of claim 4, wherein the hydrophobic solids are selected from a group comprising: treated silica, aluminum oxide, polyacrylates, acrylate esters polypropylene, or a combination thereof.

8. The defoaming compound of claim 4, wherein the surfactants is selected from a group comprising: alkyl sulfates, alkyl ethoxylate sulfates, alkyl aryl sulfonates, phosphate esters, quaternary ammonium compounds, fatty amine salts, fatty acid amides, alkyl phenol ethoxylates, ethoxylate-propoxylate polymers, fatty alcohol ethoxylates or a combination thereof.

9. A refrigerant composition comprising the defoaming compound of claim 1, wherein the defoaming compound is from about 0.0001% to about 1% by weight of the refrigerant composition.

10. The refrigerant composition of claim 9, wherein the defoaming compound is from about 0.0001% to 0.1%

11. The defoaming compound of claim 1, wherein a refrigerant for the refrigerant/lubricant mixture is selected from a group comprising: 1-chloro-3,3,3 trifluoropropene (E), 1-chloro-3,3,3 trifluoropropene (Z), 2-chloro-3,3,3 trifluoropropene, 1,1,dichloro-3,3,3 trifluoropropene, 1,2 dichloro-3,3,3 trifluoropropene (E), 1,2 dichloro-3,3,3 trifluoropropene (Z), 1,3,3,3 tetrafluoropropene (E), 1,3,3,3 tetrafluoropropene (Z), 2,3,3,3, tetrafluoropropene, 1,1,2 trichloro-3,3,3 trifluoropropene, 1,2 dichloroethylene (E), 1,2 dichloroethylene (Z), 1,1 dichloroethylene, 1,1,1,4,4,4 hexafluorobutene (Z), 1,1,1,4,4,4 hexafluorobutene (E), 1,1,3,3 tetrafluoropropane, 1,1,1,2,3 pentafluoropropane, 1,1,2,3,3 pentafluoropropane, 1,1,1,3,3 pentafluoropropane, 1,1,1,2,2 pentafluoropropane, 1,1,1,2,2,3 hexafluoropropane, 1,1,1,2,3,3 hexafluoropropane, 1,1,1,3,3,3 hexafluoropropane, isopentane, pentane, cyclopentane, 1,1 difluoroethene, 1,2-difluoroethane, difluoromethane, 1,1,1,2 tetrafluoroethane, R1234ze (E), 1, 1 difluoroethane, 1,2 difluoroethene (E), 1,2 difluorethene (Z).

12. An additive for a HVAC system comprising the defoaming compound of claim 1.

13. A refrigerant composition comprising the additive of claim 12, wherein the additive is from about 0.0001% to about 1% by weight of the refrigerant composition.

14. The refrigerant composition of claim 13, wherein the additive is from about 0.0001% to 0.1%.

15. A lubricant composition for a HVAC system, comprising about 0.00025% to 0.0075% of silicone oil.

16. The lubricant composition of claim 15, wherein the silicon oil is about 0.00025% to 0.005%.

17. The lubricant composition of claim 15, wherein the silicon oil is 0.005%.

18. A lubricant composition for a HVAC system, comprising 0.00025% to 0.1% of polyacrylates, acrylate esters or a combination thereof.

19. The lubricant composition of claim 18, wherein the polyacrylates, acrylate esters or a combination thereof is about 0.05%.
